(19) United States
(12) Patent Application Publication
(10) Pub. No.: US 2002/0083740 A1
(43) Pub. Date: Jul. 4, 2002

(54) Process and apparatus for production of silica grain having desired properties and their fiber optic and semiconductor application

(76) Inventor: Kiril A. Pandelisev, Mesa, AZ (US)

Correspondence Address: James C. Wray, Suite 300, 1493 Chain Bridge Road, McLean, VA, 22101, US

(21) Appl. No.: 09/881,092

(22) Filed: Jun. 15, 2001

Related U.S. Application Data
(60) Provisional application No. 60/258,494, filed on Dec. 29, 2000.

(51) Int. Cl. C03B 37/018; C03B 19/01

(52) U.S. Cl. 65/391; 65/17.4; 65/86; 65/110; 65/111; 65/183; 65/126; 65/32.5; 65/32.1; 65/21.1; 65/436

(57) ABSTRACT

Silica grain of desired properties and size is created in a vacuum chamber. Fine silica powder is injected in the chamber or silica powder is formed in situ by combusting precursors. A plasma is formed centrally in the chamber to soften the silica powders so that they stick together and form larger grains of desired size. The grains are collected, doped, fused and flowed into tubes or rods. A puller pulls the tube or rod through a chamber seal into a lower connected vacuum chamber. The tube or rod is converted to rods and fibers or plates and bars in the connected chamber. Fused silica in a crucible tray is subjected to ultrasound or other oscillations for outgassing. Gases are removed by closely positioned vacuum ports.

This application claims the benefit of U.S. Provisional Application No. 60/258,494, filed Dec. 29, 2000.

### BACKGROUND OF THE INVENTION

Silica powders are used in the production of silica glass products such as optical windows, scintillators and optical filters.

Fine control of the processes is required to produce end products with desired characteristics. Variations in characteristics result in products with little or no economic value.

Needs exist for better starter materials to ensure uniformity of products.

### SUMMARY OF THE INVENTION

Silica grains of desired sizes and desired compositions and doping for use as starter materials in silica products are produced using the present invention.

According to the invention, silica powders are introduced or created in a vacuum chamber.

A gas or gases plasma heats the powders rendering them sticky. The surfaces melt and the powder particles agglomerate and fuse into larger particles as they pass through the plasma.

Microwave/electron cyclotron resonance (MW-ECR) or other methods for generating plasma may be introduced in the chamber. Argon, nitrogen, ammonia, oxygen and other gasses may be used for the plasma. One or more sources producing the same or different gas plasma may be coupled with the same chamber. The plasma ports all may be directed at the same chamber section, or they may be cascaded in specific orders. Each chamber may contain one or more plasma generators resulting in certain plasma density. Such chambers may form a cascade. Fused silica grains traveling through the cascade may experience increase or decrease in temperature. The same vacuum or different vacuums may be present at each plasma port. The plasma ports may be within one chamber or they may be in separate chambers. Chambers may be separated or not separated by gate valves. Plasma chamber cascades may be employed to achieve the desired grain properties. The plasma flow may consist of pure plasma, plasma and carrier gas, or plasma and neutral gas. The plasma may have, plasma and any mixture of neutral gases. The plasma density and temperature may be adjusted to fit the grain size of the fused silica introduced in the chamber in order to obtain certain desired grain size, grain size distribution and OH content.

Microwave electron cyclotron resonance plasma (MW-ECR) sources, among any other plasma generators may be used for production of synthetic fused silica grain of desired size or for processing of natural quartz powder into powder with certain grain size and quality. The plasma source used will allow for clean, temperature and density controlled stream of plasma that will allow for controlling the fused silica or natural quartz grain temperature for certain periods of time.

Synthetic fused silica powder may be introduced in the chamber as powder, powder and plasma mix, powder obtained via pyrolisis of silicon tetrachloride, silicon tetra fluoride, organosilicate compounds, and other silicon based compounds, organic or inorganic. When subjected to heat, plasma stream, EM field or other methods suitable for this purpose the powder will result in fused silica particles having the desired purity, OH content and particle size distribution.

Ion temperatures in the vicinity of 1 eV and electron temperatures between 4-7 eV may be used. The density of the plasma (˜10¹⁰ cm⁻³) and its temperature are determined by the plasma source array and the placement of each plasma generator and they will determine the temperature of the silica grain and how much it will fuse into larger grains of silica. A plasma exposure cascade may further enhance the grain size to the desired grain volume or grain weight. Heating individual grains to such high temperatures before the fusion and after the fusion and possibly repeating this process within a cascade of plasma exposure eliminates OH group presence in the fused silica and the reaction with various gases in plasma or neutral state can further purify the silica grain and the soot produced from the same. Repeat of the silica grain with plasma/neutral gas interaction, and the appropriate time length for the contact will determine the appropriate temperature of the reaction taking place and the fusion between different grains into grains having desired grain size and purity. Reactive plasma such as atomic chlorine, fluorine and other ions may be used to remove certain impurities in the fused silica grain.

Dopant may be introduced in gaseous, liquid or solid state for doping of the grains while they are fusing or as a later step in the fused silica processing.

Additional grain heating by means of resistive, RF or any other heating methods may be used. Multi zone heating arrangement in the chamber may be applied for this purpose. Equilibrium chamber vacuum or differential vacuum may be present during the synthetic fused silica or natural quartz grain processing.

The so purified material can remain in granular state, or it can be deposited on a bait that can be made of quartz, graphite, silicon carbide, ceramic, metal or metal alloy that possesses any porosity: from very porous to solid material. The bait can have any desired shape and cross section to better suit the step processing of the fused silica.

In one embodiment synthetic fused silica or natural quartz powder may be introduced simultaneously. The plasma heated powder jets from plurality of ports enter the chamber and they are “contained” within certain elliptically shaped cloud. Other plasma for additional grain heating and purification may be introduced in the particle cloud. Reactive gasses in plasma or neutral state may also be introduced in the particle cloud for purification or other purposes.

The grains collide among themselves forming larger grains. The high temperature of the grain provides for removal of the OH content in the grain. The high temperature of the grain and the reactions the grain is subjected to in the particle cloud or in the chamber in general provides for removal of various trace elements that are pumped out in gaseous form.

Such produced grain may be subjected to a cascade of individual or interconnected chambers that further contribute to the grain size, grain size distribution and grain purity.

In another embodiment the powder is deposited in a tray that can be heated. Synthetic fused silica or natural quartz having desired purity, OH content and grain size distribution is obtained. This powder can further be used in various processes for fabrication of fiber optic preforms, synthetic fused silica, natural quartz or their combination made into tubes for modified chemical vapor deposition (MCVD), for fabrication of fiber optic preforms, doped or undoped cores for axial vapor deposition methods, for fiber optic preforms fabrication, solid rods and plate shaped members for semiconductor wafers and optical components fabrication.

These and further and other objects and features of the invention are apparent in the disclosure, which includes the above and ongoing written specification, with the claims and the drawings.

### BRIEF DESCRIPTION OF THE DRAWINGS

FIGS. 1-16 discuss different embodiments for the synthetic fused silica fabrication, applications and products made by the same.

FIG. 1 show forming of fused silica grains from powder particles.

FIG. 2 shows collecting, treating and processing the fused silica grains.

FIG. 3 adds electrodes and an electric field to the softened fused silica.

FIG. 4 shows double crucible used in the process.

FIG. 5 shows direct plate or bar formation.

FIG. 6 is a schematic perspective representation of a porous preform-general chamber, which may be horizontal, vertical or any other position.

FIG. 7 shows a cross-sectional view of the chamber shown in FIG. 1, in which one or a plurality of deposition rods made from carbon, SiC, ceramic or graphite may be rotated to collect the glass soot.

FIG. 8 shows spacing of plural preforms in a chamber.

FIG. 9 shows multiple preforms with rotation and translation in the silica grain streams in the chamber.

FIG. 10 shows dopant gas distribution to and through the preform.

FIG. 11 shows rotating and translating the preform of in powder streams and forming a cladding layer.

FIG. 12 shows vitrifying and densifying a cladding layer on a core.

FIGS. 13A-13D show transforming a tubing into a solid member.

FIGS. 14A and 14B show transforming a tubing into a solid member.

FIGS. 15A and 15B show vitrifying a silica tube and the product produced.

FIG. 16 schematically shows forming a plate or bar from a tubular or rod preform formed from fused silica grains.

### DETAILED DESCRIPTION OF THE PREFERRED EMBODIMENTS

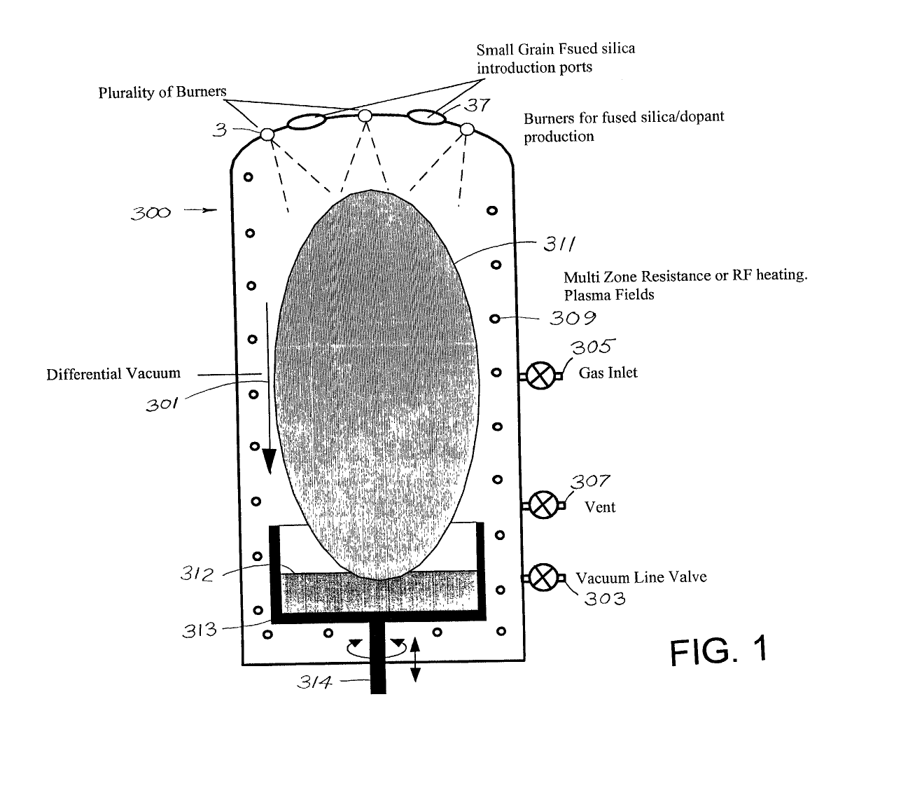

FIG. 1 shows a chamber 300 with burners 3 and small grain silica powder introduction ports 37. The burners 3 create fine silica powder from precursor materials and heat the plasma 311. A differential reduced pressure 301 is drawn on the chamber using valved vacuum line 303. A valved gas inlet 305 provides dopant gas and inert gas. A valved vent 307 removes combustion gasses and excess dopant gas. Microwave electron cyclotron resonance heaters 309 create the high temperature plasma 311. The fine grain silica powders pass through the plasma and are heated and softened. The hot soft surfaces of the fine grain powder particles cause agglomeration and fusing of the powder particles into large grain silica particles. Uniform grain size is created, and OH content is reduced or eliminated. The plasma fields are controlled so that surface melting of the increasing size particles is maintained in the plasma. The plasma 311 contains multiple heat zones. Multizone resistance or radio frequency (RF) heaters 309 may be used to maintain temperatures in plasma fields 311. The fused particles are collected in a heated rotating tray 313 which is rotated clockwise or counter clockwise or in alternating directions and elevated and lowered as sho9en by arrows with a turning and elevating device 314.

The first chamber produces silica and other soot of desired size. The vacuum chamber has plurality of vacuum ports, gas inlet ports, vent ports, reactive burners, and silica powder delivery ports. The chamber is heated by resistance or RF heating, plasma heating or any other mean of heating, connected through plurality of feedthroughs. Crucible made from graphite, silicon carbide, ceramic material, metal or metal alloys receives the material. The vacuum chamber can be multiple chambers.

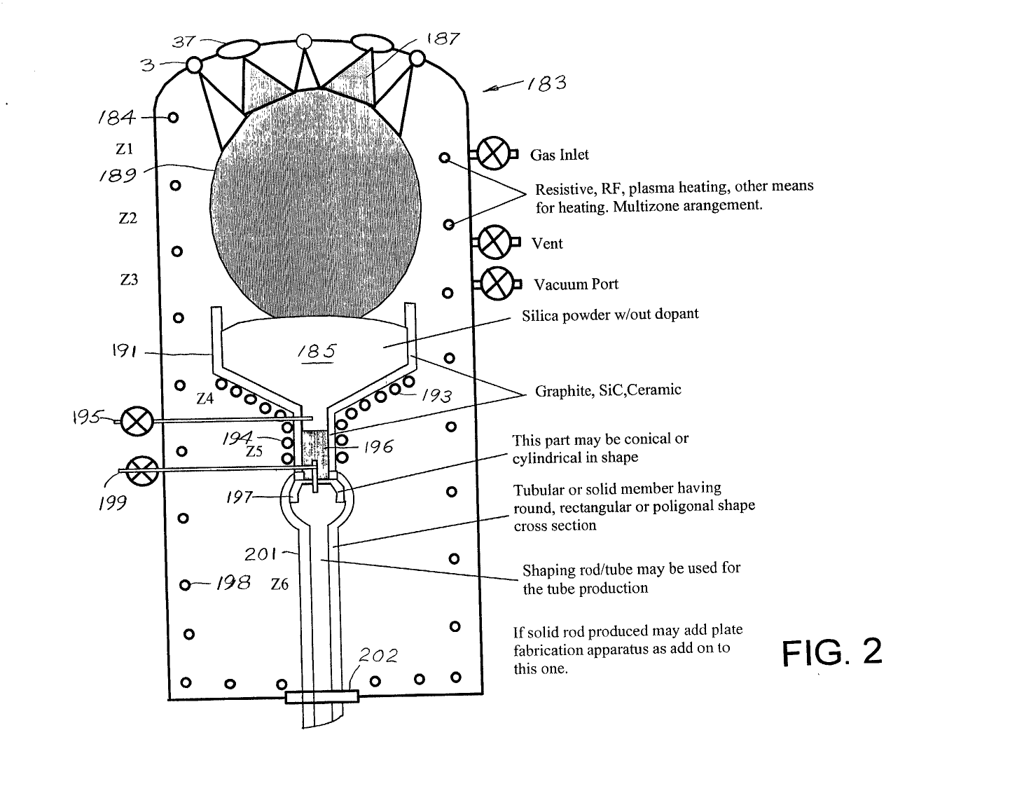

FIG. 2 shows a chamber 183 for producing silica powder 185 and other metal oxides from burners 3 and from soot 187 introduced from ports and agglomerated in plasma 189 into grains having desired particle size. Fine oxide particles, in suit made from burners 3 or delivered through plurality of ports 37 on the chamber are heated in plasma 189 and allowed to recombine. The plasma 189 is created by hot temperatures produced in inert gases by heating in a multizone arrangement. Depending on the time the particles stay hot and the distance the particles travel, they recombine into larger grains of desired size. The vacuum chamber 183 has multizone heating zones Z1-Z6 with heaters 184. Microwave electron cyclotron resonance heating, in zones Z1, Z2 and Z3 of increasing temperatures, resistive heating, RF heating of the plasma 189 or other heating methods of the grains may be employed.

The soot is collected in a crucible 191. A heater 193 in zone Z4 keeps the sized grains hot in crucible 191. The hot grains are doped using a dopant injector 195, as shown in FIG. 2. The grains 185 may be melted 196, funneled and flowed around a former 197 and filled with an inert gas with a dopant 199 or an inert gas 199 to form a tube 201. Tube 201 passes out of chamber 183 through a gate 202 after solidification in zone Z6 in which temperatures are maintained by heaters 198.

The vacuum chamber having plurality of vacuum ports, gas inlet ports, vent ports, reactive burners, and silica powder delivery ports. The chamber is heated by resistance heating, RF heating, plasma heating or any other means of heating connected through plurality of feedthroughs. A funnel made from graphite, silicon carbide, ceramic material, metal or metal alloys receives the material. The material is softened in the funnel and transformed into a fused quartz article of choice. The fused silica article can rotate clockwise or counterclockwise. This material can feed into a fabrication apparatus.

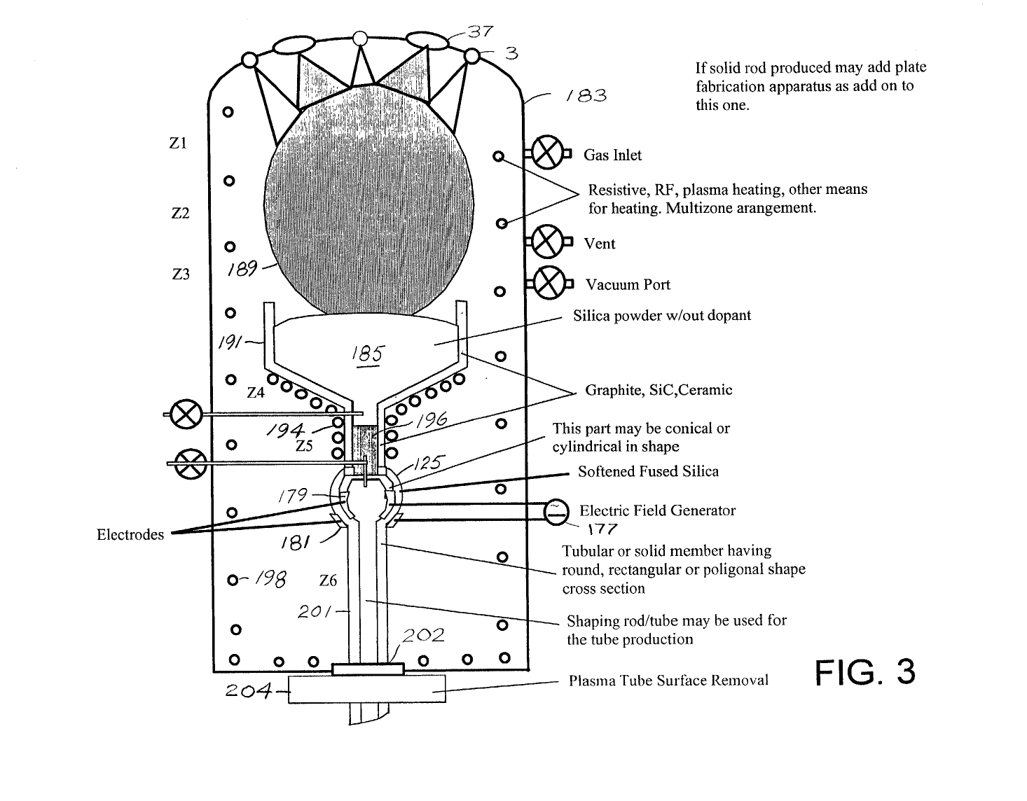

Another chamber employing the new soot grain enlargement process for tube or rod fabrication is as shown in FIG. 3. In that embodiment electric field generator 177 with electrodes 179 and 181 provides an electric field across the softened fused silica flow 125. Electrode 179 is located within the softened bubble 125 which forms tube 201. Electrode 181 is located outside the bubble 125. A plasma tube surface removal unit 204 cleans the surface of the tube in a hot plasma.

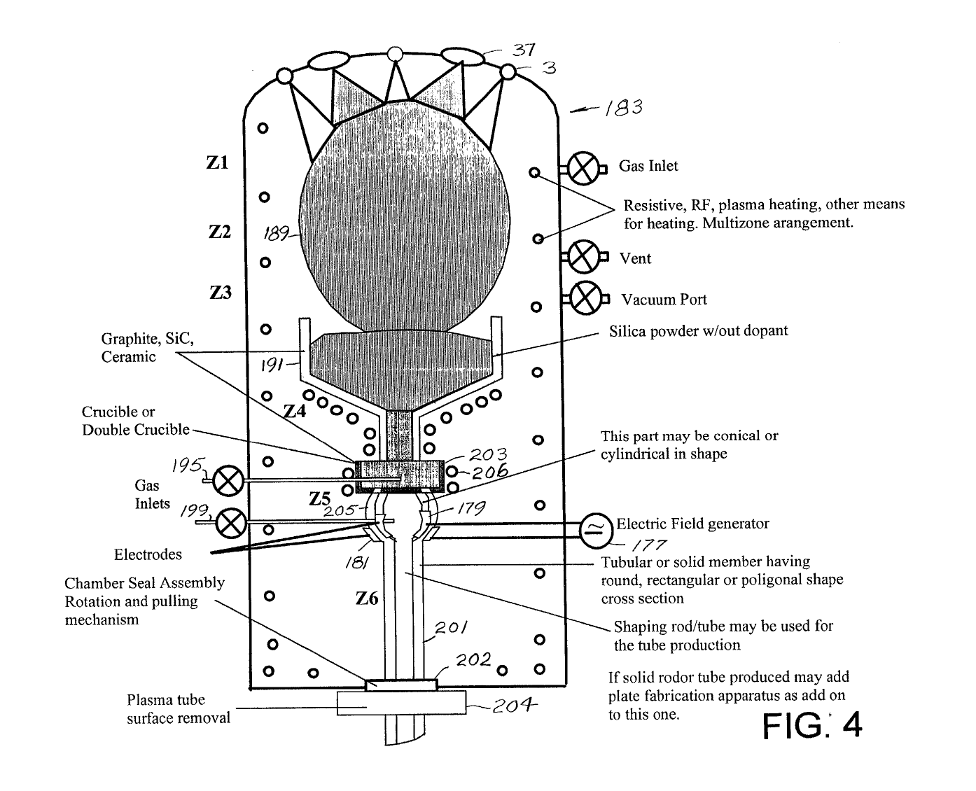

FIG. 4 shows a double crucible 203 in the chamber. A vacuum chamber 183 having plurality of vacuum ports, gas inlet ports, vent ports, and a fused silica feed material introduction port is heated by resistance or RF heating or any other means of heating, connected through plurality of feedthroughs. A second crucible 203 made from graphite, silicon carbide, ceramic material, metal or metal alloys receives, holds and melts the material from the feed crucible 191, softens the same and remelts the material. A dopant gas from tube 195 is added to the molten material in crucible 203. A fused silica tube is produced. Pluralities of ultrasound generators 206 are in contact with the crucible to provide proper mixing and outgassing. Additional vacuum ports are placed above the softened material to remove any gas bubbles. The chamber can be a single chamber or plurality of chambers.

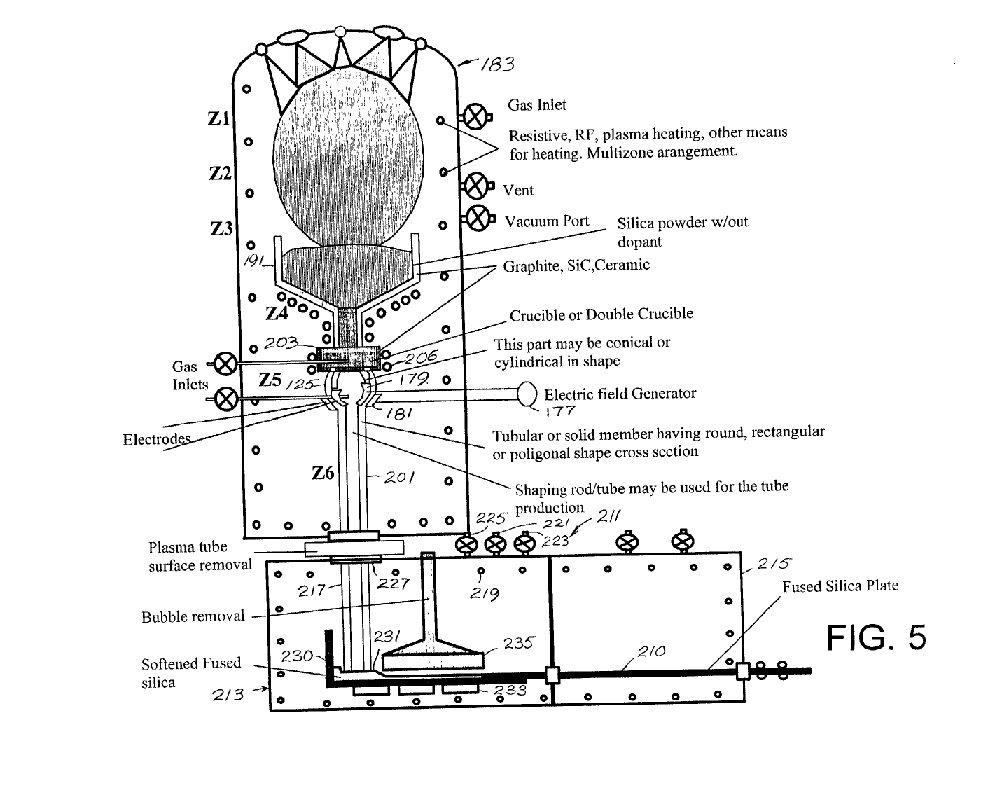

FIG. 5 shows a plate or bar forming chamber 211 in which the infeed is a tube 201 or rod. The plate or bar forming chamber 211 directly coupled to chamber 183 for receiving the fused silica tube input 217 directly from the output of chamber 183. The plate/bar fabrication chamber 211 has two separated chambers. A vacuum chamber 213 having plurality of valved vacuum ports 221, gas inlet ports 223, vent ports 225 and a fused silica feed material 217 introduction port 227 is heated by resistance of RF heating 219 or any other means of heating, connected through a plurality of feedthroughs. A crucible 230 made from graphite, silicon carbide, ceramic material, metal or metal alloys receives the material 231 from the feed tube 217, softens, dopes, degasifies and solidifies the material. A fused silica plate or a bar 210 is produced. A plurality of ultrasound generators 233 are in contact with the crucible to promote proper mixing and outgassing. Additional vacuum ports 235 are placed above the softened material to remove any gas bubbles. The chamber can be a single chamber or plurality of chambers 213, 215 with sequentially controlled heat zones.

The plate/bar fabrication chamber is a vacuum chamber having plurality of vacuum ports, gas inlet ports, and vent ports. A fused silica feed material introduction port is heated by microwave, resistance, RF heating, or any other means of heating, connected through plurality of feedthroughs. A crucible made from graphite, silicon carbide, ceramic material, metal or metal alloys receives the material form the feed rod, softens the same and solidifies the material. A fused silica plate or a bar is produced. Plurality of ultrasound generators are in contact with the crucible to promote proper mixing and outgassing. Additional vacuum ports are placed above the softened material to remove any gas bubbles. The chamber can be a single chamber or plurality of chambers.

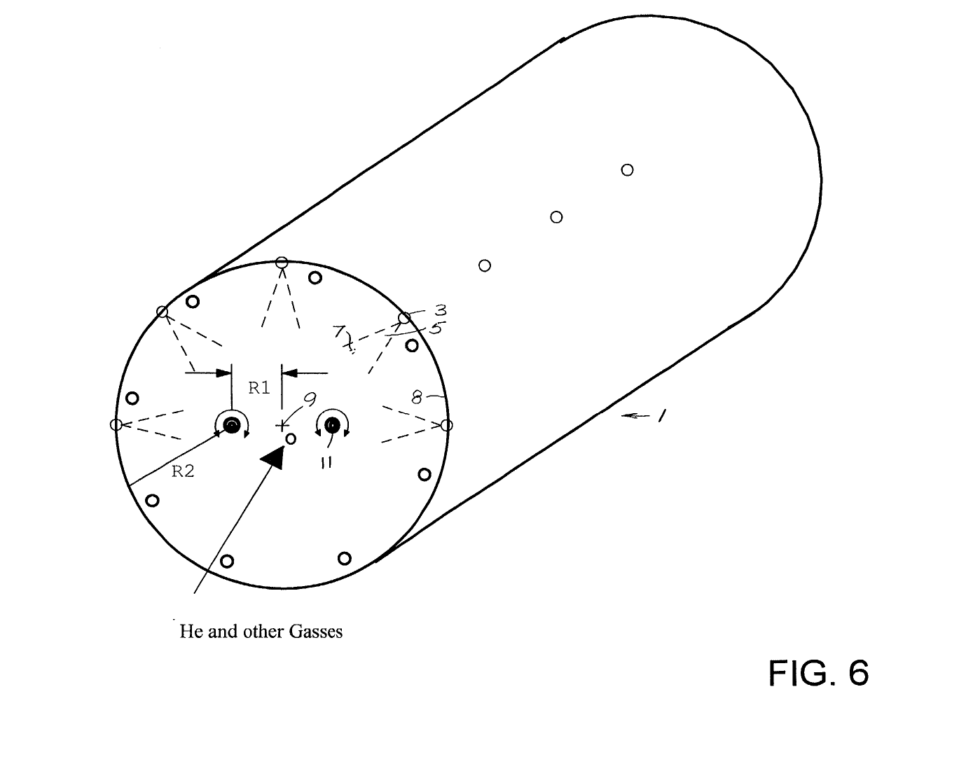

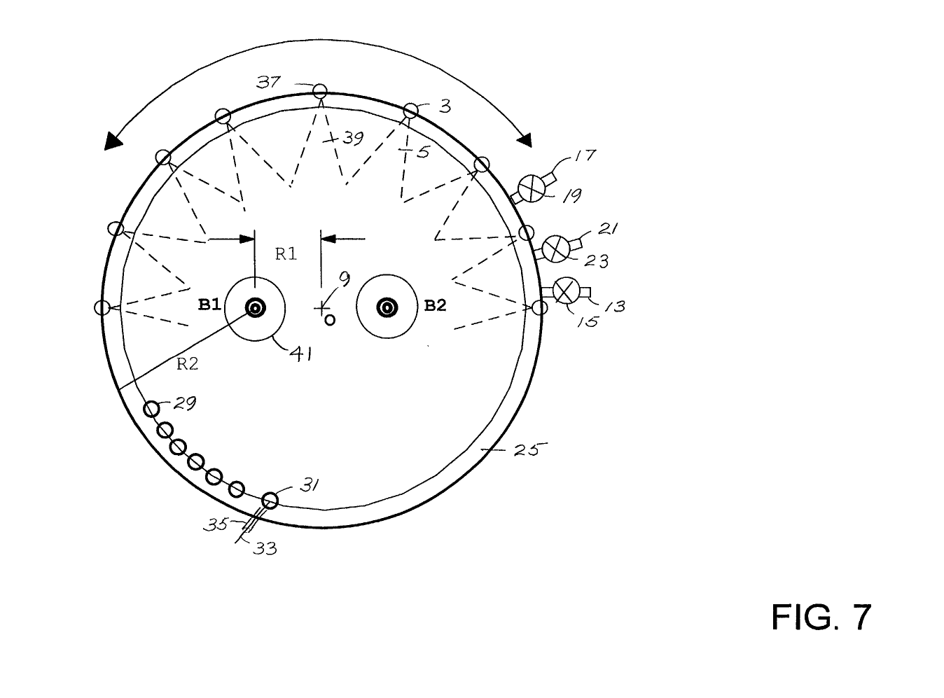

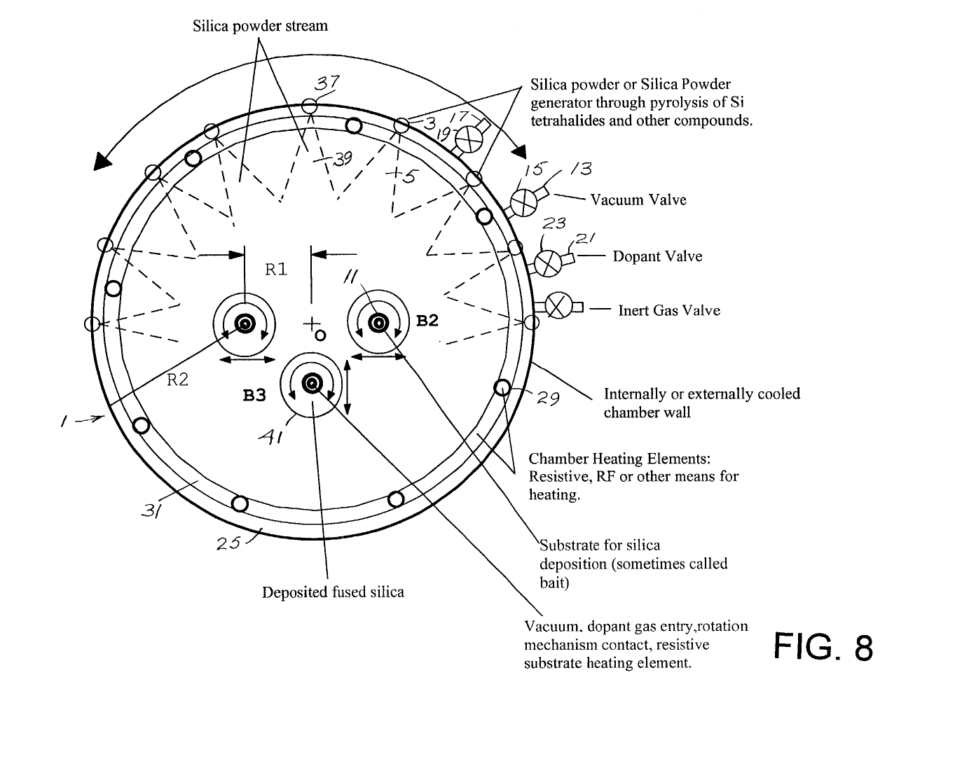

FIGS. 6 and 7 show a plurality of substrates 11 with controlled temperature housed in a vacuum chamber 1. A plurality of burners 3 for oxidation 5 of metal halides 7 such as SiCl4, SiF4 and others are either imbedded in the chamber wall 8 or they are placed inside the chamber. The proximity of the burners to the substrates 11 as well as the distance of the substrates from the center 9 of the chamber are optimized based on the number of the substrates 11, the number of the burners 3 and their relative positions. The chamber 1 may have round, rectangular or any other suitable shape that is needed to optimize the process. Vacuum ports 13 with valves 15, vents 17 with valves 19 and a plurality of gas inlet ports 21 with valves 23 are also added to the chamber. The chamber may be vertical, horizontal, sloped and any other position or combination suitable for the new process. The chamber walls 8 may have a cooling jacket 25 for temperature control and appropriate venting apparatus for the gasses generated during the deposition. Appropriate openings are provided at one end, at each end or on one or two sides of the chamber for loading and unloading of the chamber.

A plurality of power feeds for resistive heating 29 or RF coils 31 and appropriate power feedthroughs 33 and shields 35 are also included in the chamber.

The chamber may have plurality of ports 37 for introduction of soot 39 made during another operation.

The chamber and the substrate assembly may be rotated in respect to each other clockwise or counterclockwise at certain desired speeds. Each substrate may be rotated around its axis clockwise or counterclockwise at certain desired speeds. All rotations are aimed at establishing conditions for good thickness and uniformity properties of the deposited material in the porous perform 41.

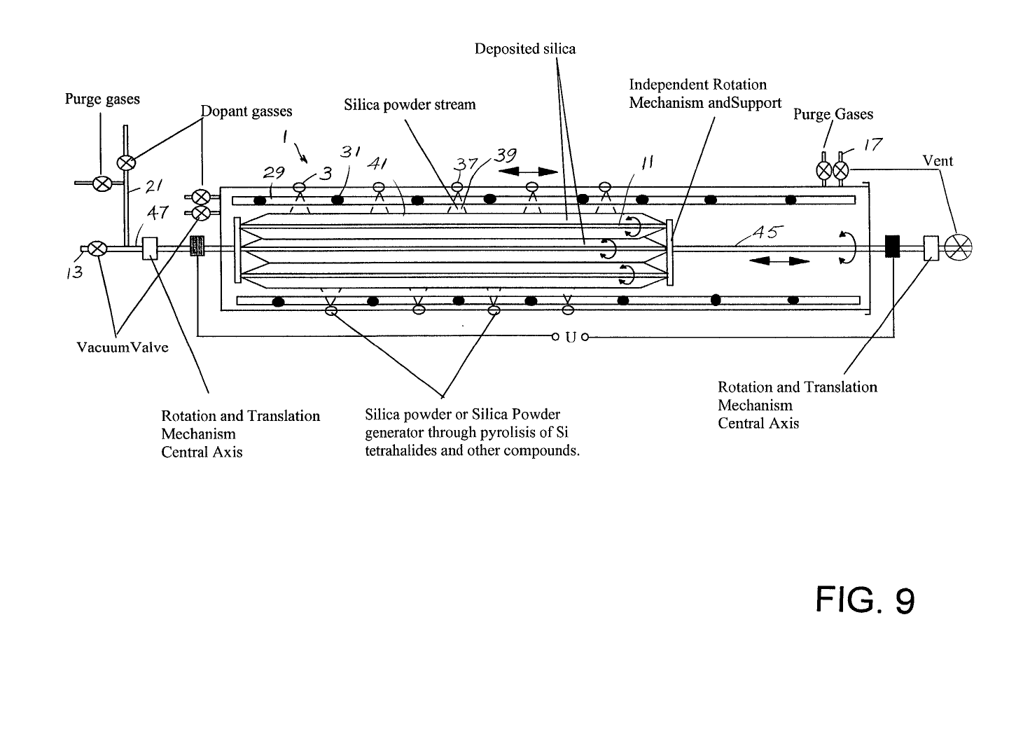

FIG. 9 shows a tubular substrate 11 with deposited material 43. Each substrate 11 may be made of solid, porous or perforated material made from graphite, silicon carbide, ceramic, metal or metal alloys. It may have round, rectangular or any other cross section. It may be tubular, solid or tubular with solid core made from the same or other material. The ends 45 may have the same cross section throughout, or the ends may have different dimensions or shapes. The ends 45 may be mechanically connected to the substrate 11 or they may be part of the substrate. A gas line 47 or vacuum line may be connected with the hollow portion of each substrate having tubular shape, with or without a central rod.

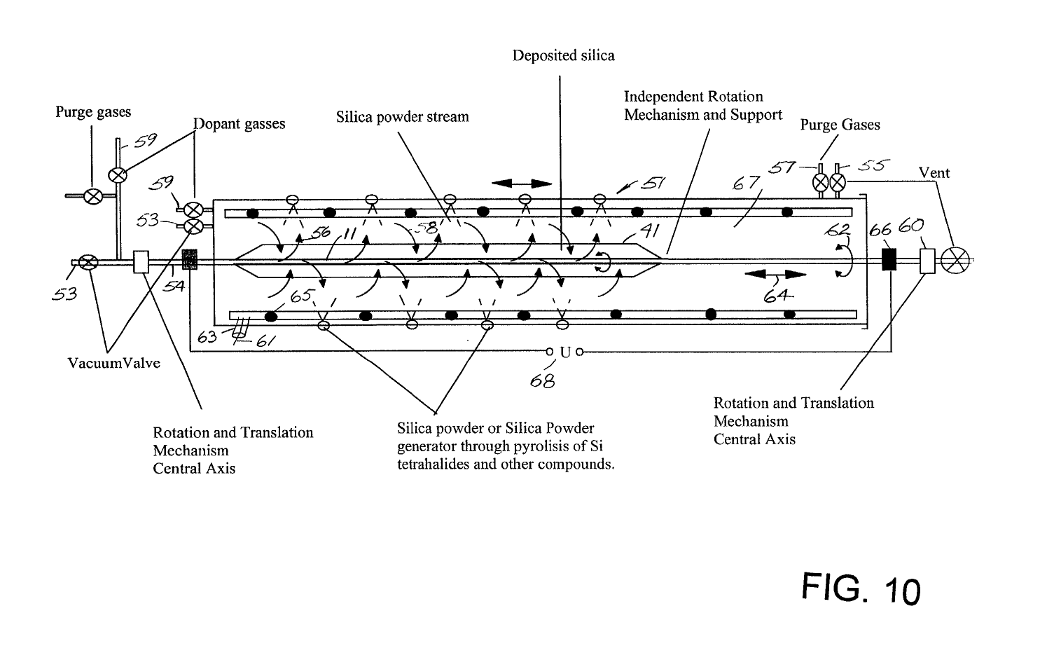

FIG. 10 shows an apparatus consisting of a vacuum chamber 51 having plurality of vacuum ports 53, vent lines 55, and gas ports 57 doping ports 59 for purging and doping purposes, plurality of power feedthroughs 61 with or without cooling lines 63 in them for resistive, RF 65 or any other form of heating the substrate 11 of the preform 41 and the preform itself. The chamber may have multiple heating zones 67 to accommodate the process being performed there. Rotation and translation mechanisms 60 rotate 62 and translate 64 the substrate 11 and preform 41. Slip rings 66 conduct power from source 68 to heat the substrate 11.

In FIG. 10 the dopant gases 58 surround the preform 41, and purge or dopant gases 56 from purge or dopant line 54 flow outward from the porous substrate through the porous preform 41.

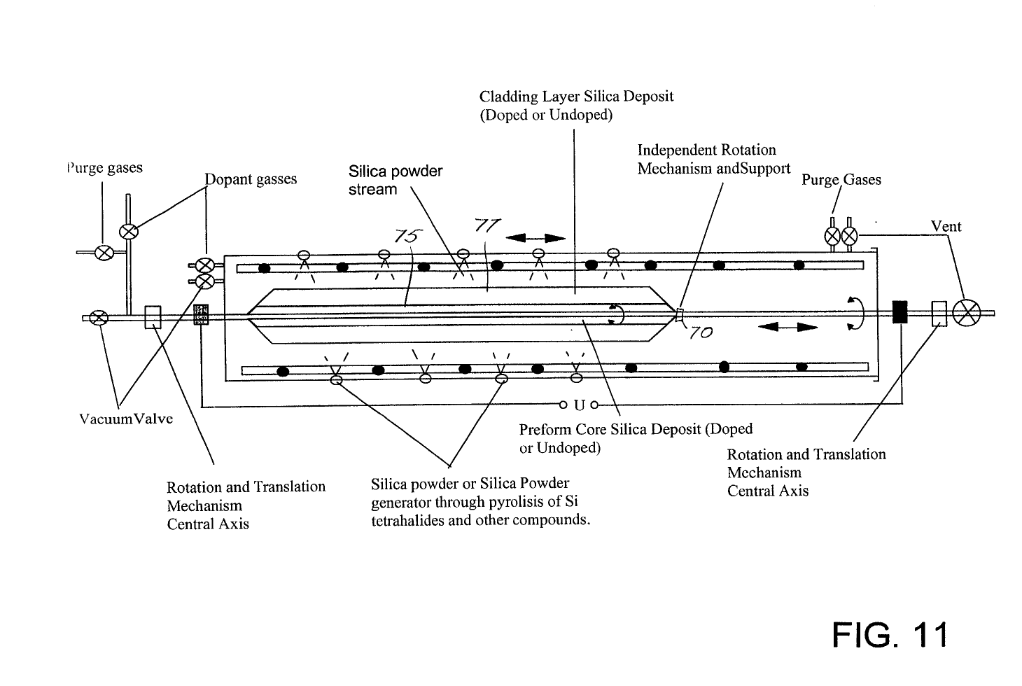

As shown in FIG. 11, a doped or undoped cladding layer 77 may be added to a doped or undoped preform core silica deposit 75. Several preforms 41 may be constructed at the same time using the independent rotation mechanism and support 70.

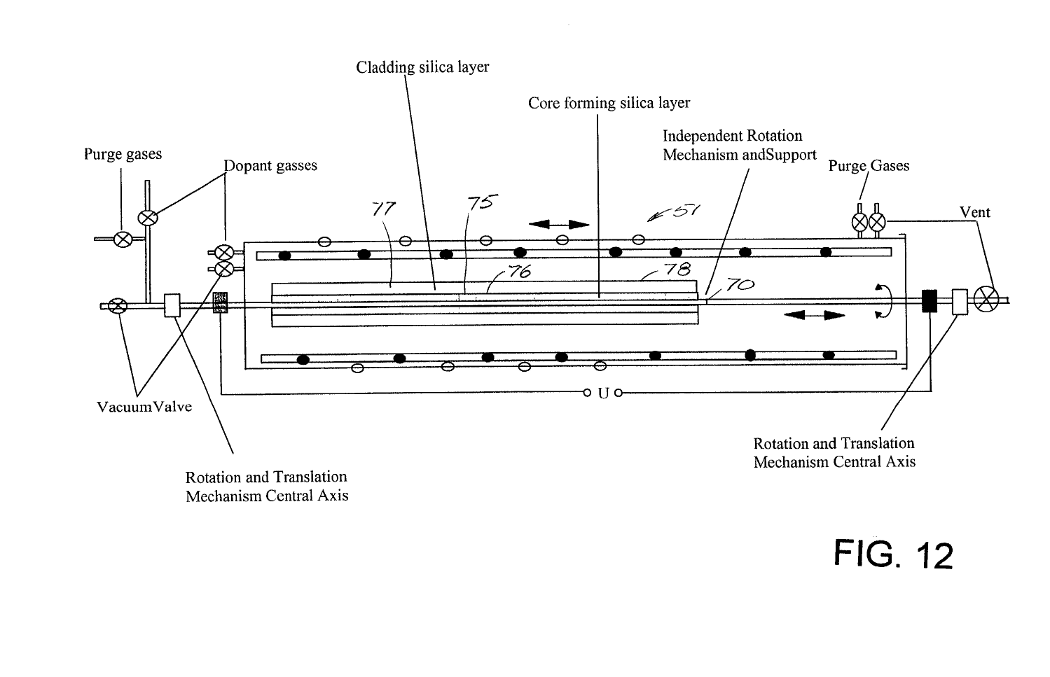

As shown in FIG. 12, the core-forming silica layer 75 may be vitrified 76 initially before deposition of the cladding layer 77, followed by vitrification 78 of the cladding layer, all within the single chamber 51. The independent rotation mechanism 70 permits deposit and vitrification of layers on multiple preforms concurrently.

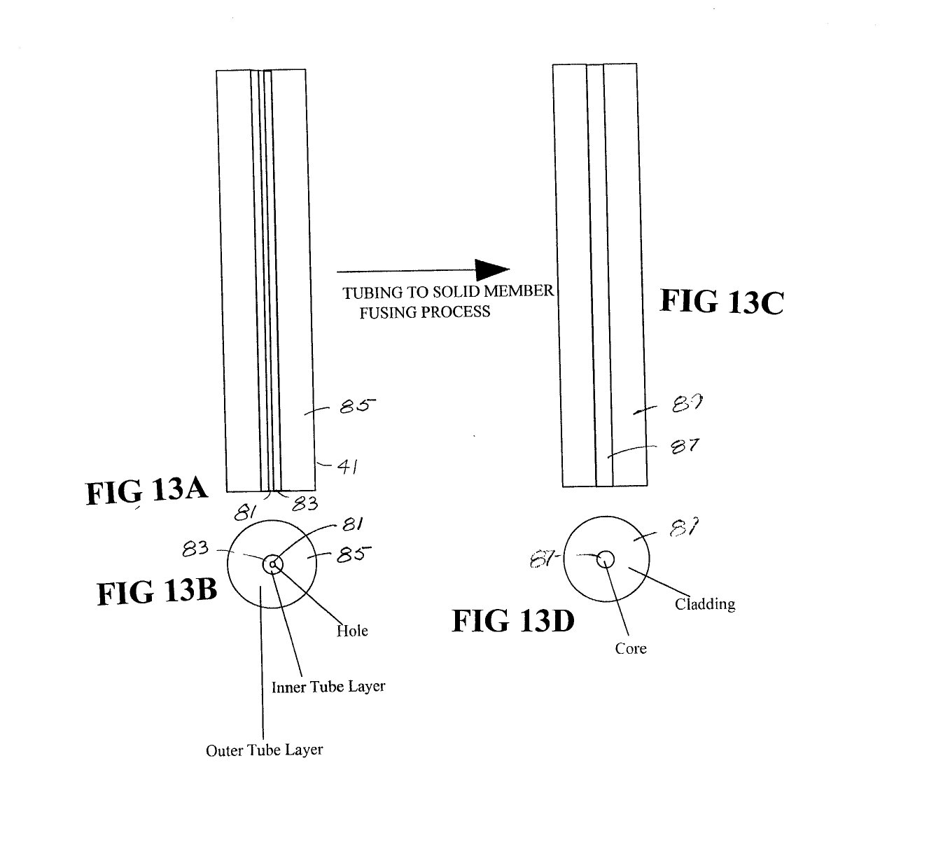

FIGS. 13A and 13B show cross-sections of tube-shaped preforms 41 with a hole 81, an inner tubular layer 83, and an outer tubular layer 85. Supporting the preform 41 between ends, heating the preform to softening temperature and rotating the preform shrinks the preform to the solid member 86 with a solid core 87 and cladding 89, as shown in FIGS. 13C and 13D.

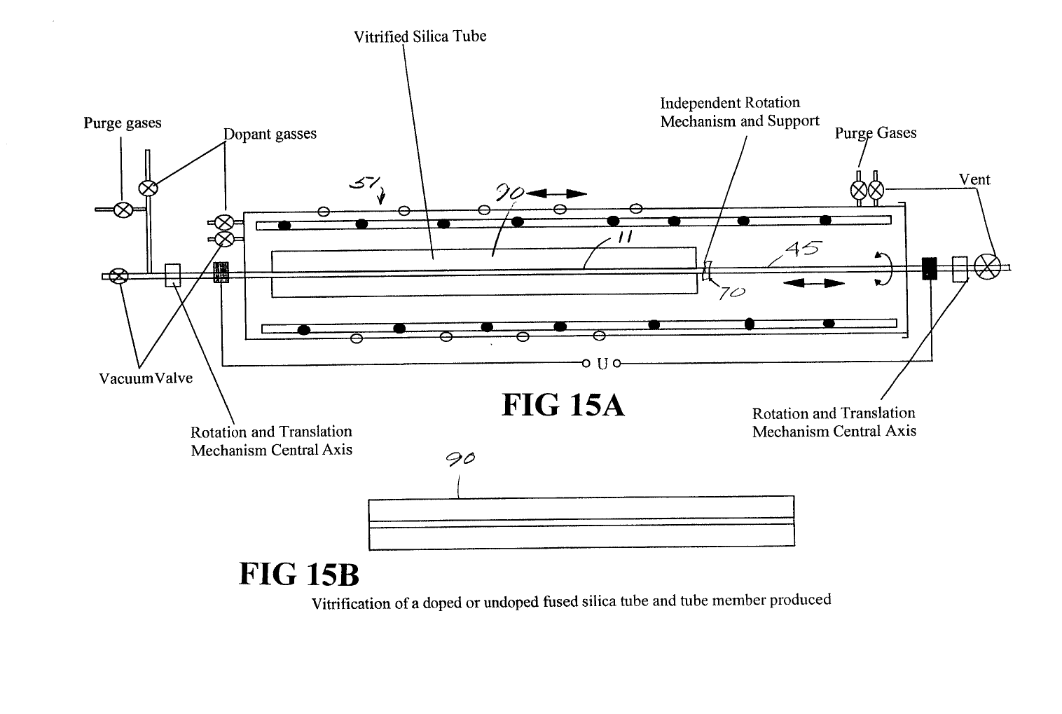

FIG. 15A shows a vitrified silica tube 90 in a chamber 51. The vitrified tube 90 is removed from the chamber, as shown in FIG. 15B. Detaching the independent rotation mechanism from support ends 45 allows the substrates to be detached from the mechanism 70. Alternatively, the mechanism may be left in place on the support 45 while the individual substrates 11 are removed.

When the substrate is fused silica, the tube is ready to be used or ready to be softened and to be compacted and densified into a solid.

Alternatively, the substrate 11 may be heated, and the fused silica tube 90 may be slid off the substrate after a film is melted adjacent the substrate, after the ends 91 are removed as shown in FIGS. 12A and 12B.

The tubing 90 that is removed has a hole 93 and a tube wall 95, as shown in FIG. 13A, before it is compressed into a solid doped fused silica rod 97, as shown in FIG. 13B.

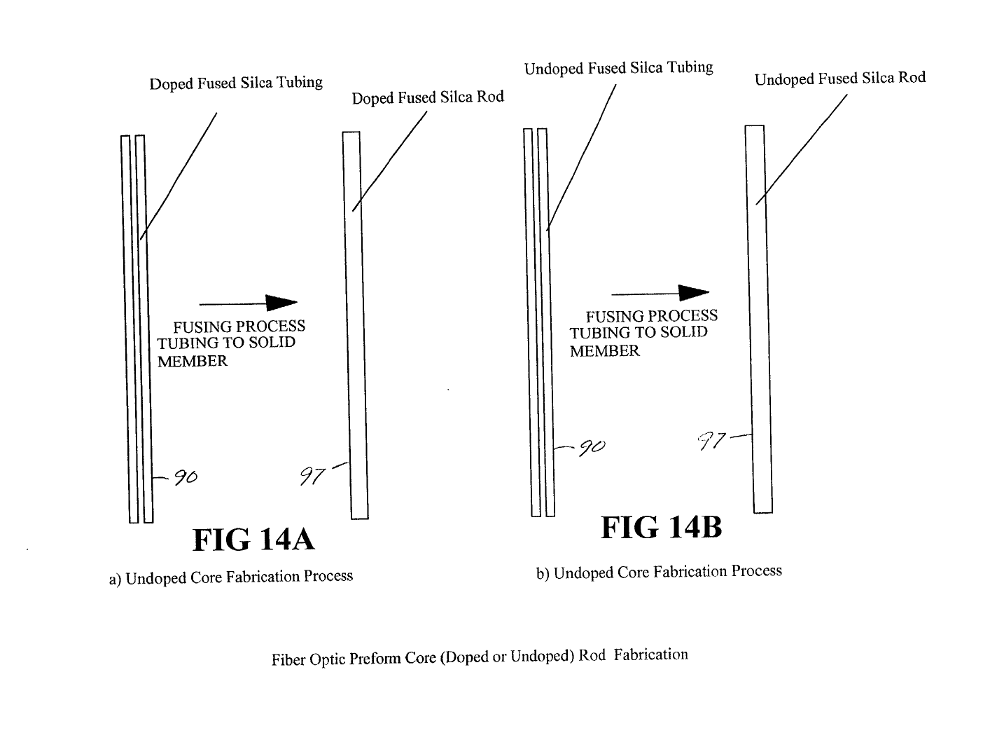

FIGS. 14A and 14B show fusing a doped fused silica tubing 90 to a doped fused silica rod 97.

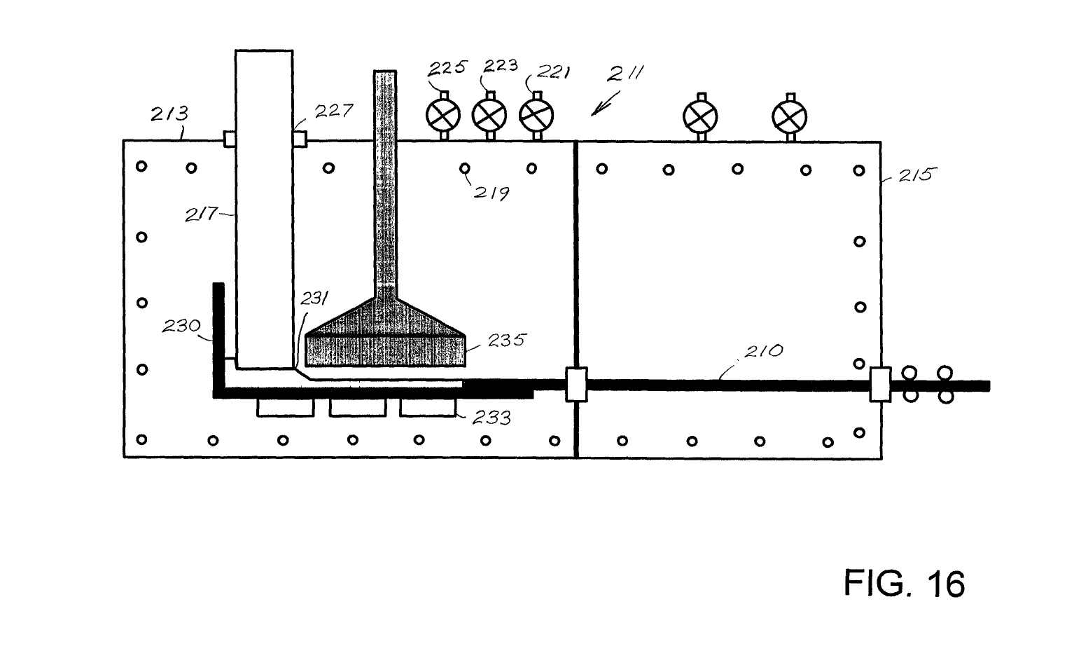

FIG. 16 shows a plate/bar fabrication chamber 211. A vacuum chamber 213 having plurality of valved vacuum ports 221, gas inlet ports 223, vent ports 225 and a fused silica feed material 217 from introduction port 227 is heated by resistance or RF heating 219 or any other means of heating, connected through a plurality of feedthroughs. A crucible 230 made from graphite, silicon carbide, ceramic material, metal or metal alloys receives the material 231 from the feed tube 217, and softens, dopes, degasifies and solidifies the material. A fused silica plate or a bar 210 is produced. A plurality of ultrasound generators 233 are in contact with the crucible to prevent proper mixing and outgassing. Additional vacuum ports 235 are placed above the softened material to remove any gas bubbles. The chamber can be a single chamber or plurality of chambers 213, 215 with sequentially controlled heat zones.

FIG. 16 also shows a plate or bar forming chamber 211 in which the infeed 217 is a solid rod.

The heating of the substrate may be accomplished by separate heaters positioned axially along or in the substrate. Alternatively if resistance heating is used, the heating wire may be varied in shape, form or size along the length of the substrate. The substrate may be linear or planar and may be made in one element or plural elements. A singe control or multiple independent controls may be used. The varied heating of the substrate may be used to effect uniformity of the preform in an axial direction. Alternatively the varied heating may be used to effect varied densities or porosities of the perform along it's length or per unit area.

### EXAMPLES

Silica Glass Body Fabrication

Production of synthetic fused silica glass bodies having controlled density and desired size and shape have been of interest to the natural quartz or synthetic fused silica glass industry for some time. The densities of the formed silica body mainly depend on the temperature of the flame, the distance between the substrate and the burner, and rotational and translational speeds of the substrate. Densities between 10% and 30% have been reported by this approach. The size of the body and the optimal ratio between the wall thickness (Wₜ) and the outside diameter (Dₒ), Wt/Dₒ, as well as the ratio between the outside diameter (Dₒ) and the Inside diameter (Dᵢ), Dₒ/Dᵢ, and the way the body is held during the deposition depend greatly on the density of the body surface temperature and the body density.

To overcome the current limitations and to produce large glass bodies made from synthetic fused silica, natural quartz or combination thereof, substrate heating and surface heating has been introduced. The amount of the surface heating will greatly depend on the substrate temperature, the chamber pressure, the size of the quartz particles and their temperature at impact of the surface and the size of the quartz member fabricated. Silica preforms, doped or undoped, having desired density and optimized diameter ratio can be fabricated following the examples shown below.

### Example No. 1

### Silica Body Fabrication

A heated substrate having temperature of about 1000°-1400° C. is subjected to plurality of silica particle stream either generated in situ by high temperature reactions of silica precursors, or fabricated in a separate process and then introduced via ports on the chamber in pure form, doped form, mixed with neutral gas, gas plasma or combination thereof. The so accelerated particles collide with the substrate and deposit themselves on the substrate. Subsequent particles deposit on the material already deposited, and layer by layer the silica member is formed. The silica particle stream may be doped or undoped. The temperature of the substrate might be sufficient to keep the surface of the so formed body at the same temperature. The silica body so formed is hot enough to allow for formation of a solid fused silica body. Densities between 80% and 100% may be expected as a result.

The substrate may be tubular or solid form having the desired diameter and cross section. Desired ratios between the outside and inside diameters may be obtained using this method. If tubular, the substrate may be solid or porous, depending on the dopant or reactive gas flow desired. This achieves optimized silica material-to-gas contact. The hot substrate may also serve as a heater for the dopant gas and increased reaction time. Porous substrates can also diminish the possibility of gas bubbles entrapment near the surface of the substrate.

Substrate and surface temperatures between about 700° C. and 1600° C. may result in various silica densities from 10% to 100%. Controlling the fused silica body temperature by controlling the substrate and surface temperature may result in control of the pore size and pore density in the material. If the variation is in the radial direction, exposure to dopant gas over periods of time will result in radial gradient of the dopant distribution. By doing so silica members having radially graded indexes of refraction may be fabricated.

If the substrate is other than a silica core, doped or undoped made from fused silica or natural quartz; the resulting silica member may be in tubular form or may be in solid form after collapsing the tube.

Employing non uniform substrate heating along the length of the body, one may obtain a silica member having variable density over its length.

### Example No. 2

### Doped and Undoped Layer Combination Silica Body Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited, and layer by layer the silica member is formed. A porous silica body having about 25-35% solid glass density is obtained by this process.

Step 2.

Introducing silicon tetra fluoride, SiF₄, through the porous substrate and/or the chamber into the deposited porous silica material for about 0.3 to 6 hours at temperature of about 800-1400° C., the silica material is doped.

Step 3.

The substrate and/or chamber temperature is raised to about 1400-1600° C. while rotating the substrate. A vitrified tubular silica body having desired wall thickness is formed.

Step 4.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 5.

The substrate and/or chamber temperature is raised to about 1400-1600° C. while rotating the substrate. The newly deposited porous silica is vitrified, and a tubular silica body having desired doped inner wall thickness IWₜ and undoped other wall OWₜ desired wall thickness is formed. The duration of the silica deposition for certain substrate cross sections and sizes can be adjusted to allow for various ratios between the wall thicknesses of the doped and undoped portion of the tubular member, e.g., 1:2, 1:3, 1:5, etc.

### Example No. 3

### Doped Non-Porous and Undoped Porous Layer Combination Silica Body Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited, and layer by layer the silica member is formed. A porous silica body having about 25-35% solid glass density is obtained by this process.

Step 2.

Introducing silicon tetra fluoride, SiF₄, through the porous substrate and/or the chamber into the deposited porous silica material for about 0.3-6 hours at temperature of about 800-1400° C., the silica material is doped.

Step 3.

The substrate and/or chamber temperature is raised to about 1400-1600° C. while rotating the substrate. A vitrified tubular silica body having desired wall thickness is formed.

Step 4.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process. The duration of the silica deposition for certain substrate cross sections and sizes can be adjusted to allow for various ratios between the wall thicknesses of the doped and undoped portion of the tubular member, e.g., 1:2, 1:3, 1:5, etc.

### Example No. 4

### Undoped Core and Fluorine Doped Cladding Fiber Optic Preform Fabrication

Step 1.

Rotating and translating, a substrate consisting of porous tubing is heated to a temperature of about 1300° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for about 0.3-6 hours at temperature of about 800-1400° C., the silica material is doped.

Step 5.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 6.

The substrate is transferred out of the deposition chamber area, and the substrate is removed. If wetting between the substrate and silica occurs, the substrate is heated to the softening point of the silica. The contact between the substrate and the silica member is melted and the substrate is removed.

Step 7.

The so formed silica member is collapsed and a solid rod like silica member is formed. Undoped core (high index of refraction material) surrounded by fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 5

### Doped Core and Fluorine Doped Cladding Fiber Optic Preform fabrication

Step 1.

Rotating and translating, a substrate consisting of porous tubing is heated to a temperature of about 1300° C. and is subjected to plurality of silica and dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 1.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for about 0.3-6 hours at temperature of about 800-1400° C., the silica material is doped.

Step 5.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 6.

The substrate is transferred out of the deposition chamber area and the substrate is removed. If wetting between the substrate and silica occurs, the substrate is heated to the softening point of the silica. The contact between the substrate and the silica member is melted, and the substrate is removed.

Step 7.

The so formed silica member is collapsed and a solid rod like silica member is formed. Undoped core (high index of refraction material) surrounded by fluorine doped cladding (low index of refraction material) having desired diameter and length is formed. The duration of the silica deposition for certain substrate cross section and size can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 6

### Doped Core and Fluorine Doped Graded Index of Refraction Cladding Fiber Optic Preform Fabrication

Step 1.

Rotating and translating, a substrate consisting of porous tubing is heated to a temperature of about 1300° C. and is subjected to plurality of silica and dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

The so formed vitrified tubular silica body is heated to temperature of about 1300° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

Introducing silicon tetra fluoride, SiF₄, through the porous substrate and/or the chamber into the deposited porous silica material for T₁ hours at temperature of 800-1400° C., the silica material is doped. T□ is about 0.3 to 2 hours.

Step 5.

The substrate and/or chamber temperature is raised to about 1400-1500° C. while rotating the substrate. The newly deposited porous silica is vitrified, and a tubular silica body having desired doped inner wall thickness IWₜ and undoped outer wall OWₜ desired wall thickness is formed.

Step 6.

The so formed vitrified tubular silica body is heated to temperature of about 1300° C. and is subjected to plurality of silica particle streams introduced via ports on the chamber. The o accelerated particles collide with the substrate and deposit themselves on the substrate. Subsequent particles deposit on the material already deposited and layer by layer the silica member is formed. A porous silica body having about 25-35% solid glass density is obtained by this process.

Step 7.

Introducing silicon tetra fluoride, SiF₄, through the porous substrate and/or the chamber into the deposited porous silica material for T₂>T₁ hours at a temperature of about 1100° C.-1400° C., the silica material is doped. T₂ is about 0.4-4 hours.

Step 8.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 9.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 10.

Introducing silicon tetra fluoride, SiF₄, through the porous substrate and/or the chamber into the deposited porous silica material for T₃>T₂ hours at temperature of about 1100° C.-1400° C., the silica material is doped. T₃ is about 0.5-5 hours.

Step 11.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 12.

The so formed vitrified tubular silica body is heated to temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 13.

Introducing silicon tetra fluoride, SiF₄, through the porous substrate and/or the chamber into the deposited porous silica material for T₄>T₃ hours at temperature of about 1100° C.-1400° C., the silica material is doped. T₄ is about 0.6 to 6 hours

Step 14.

The substrate and/or chamber temperature is raised to 1400-1600° C. while rotating the substrate. The newly deposited porous silica is vitrified and a tubular silica body having desired doped inner wall thickness IWₜ and undoped outer wall OWₜ desired wall thickness is formed.

Steps 15-17.

Repeat Steps 12-14 while further reducing the exposure to gaseous dopant, SiF4 in this case.

Step 18.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 19.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross section and size can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length.

### Example No. 7

### Doped Core Having Graded Index of Refraction and Fluorine Doped Graded Index of Refraction Cladding Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle streams and reduced dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced dopant particle streams introduced via ports on the chamber. The accelerated particles collide with the substrate and deposit themselves on the substrate. Subsequent particles deposit on the material already deposited and layer by layer the silica member is formed. Porous silica body having about 25-35% solid glass density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9

Repeat steps 4-6 further reducing the dopant levels in the deposited silica by lowering the dopant concentrations in the dopant particle streams, etc.

Step 10.

The so formed vitrified tubular silica body is heated to temperature of 1300° C. and is subjected to plurality of silica particle stream introduced via ports on the chamber. The so accelerated particles collide with the substrate and deposit themselves on the substrate. Subsequent particles deposit on the material already deposited and layer by layer the silica member is formed. Porous silica body having 25-35% solid glass density is obtained by this process.

Step 11.

Introducing silicon tetra fluoride, SiF₄, through the porous substrate and/or the chamber into the deposited porous silica material for T₁ hours at temperature of about 1100° c.-1400° C. the silica material is doped. T₁ is about 0.3 to 2 hours.

Step 12.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 13.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. Porous silica body having about 25-35% solid glass density is obtained by this process.

Step 14.

Introducing silicon tetra fluoride, SiF₄, through the porous substrate and/or the chamber into the deposited porous silica material for T₂>T₁ hours at temperature of about 1100° C.-1400° C. the silica material is doped. T₂ is about 0.4 to 4 hours.

Step 15.

The substrate and/or chamber temperature is raised to about 1400-1500° C. while rotating the substrate. The newly deposited porous silica is vitrified, and a tubular silica body having desired doped inner wall thickness IWₜ and undoped outer wall OWₜ desired wall thickness is formed.

Step 16.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 17.

Introducing silicon tetra fluoride, SiF₄, through the porous substrate and/or the chamber into the deposited porous silica material for T₃>T₂ hours at temperature of about 1100° C.-1400° C. the silica material is doped. T₃ is about 0.6 to 6 hours.

Step 18.

The substrate and/or chamber temperature is raised to about 1400-1600° C. while rotating the substrate. The newly deposited porous silica is vitrified, and a tubular silica body having desired doped inner wall thickness IWₜ and undoped outer wall OWₜ desired wall thickness is formed.

Step 19.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having 25-35% solid glass density is obtained by this process.

Step 20.

Introducing silicon tetra fluoride, SiF₄, through the porous substrate and/or the chamber into the deposited porous silica material for T₄>T₃ hours at temperature of 1100° C.-1400° C., the silica material is doped. T₄ is about 0.6 to 6 hours

Step 21.

The substrate and/or chamber temperature is raised to about 1400-1600° C. while rotating the substrate. The newly deposited porous silica is vitrified and a tubular silica body having desired doped inner wall thickness IWₜ and undoped outer wall OWₜ desired wall thickness is formed.

Step 22-24.

Repeat Steps 12-14 while further reducing the exposure to gaseous dopant, SiF4 in this case.

Step 25.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 26.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the as deposited preform.

### Example No. 8

### Doped Core Having Graded Index of Refraction and Fluorine Doped Cladding Having Graded Index of Refraction Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle stream and reduced concentration dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced concentration dopant particle stream introduced via ports on the chamber. The so accelerated particles collide with the substrate and deposit themselves on the substrate. Subsequent particles deposit on the material already deposited and layer by layer the silica member is formed. A porous silica body having about 25-35% fused silica density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9.

Repeat steps 4-6 further reducing the dopant levels in the deposited silica by further lowering the dopant concentrations in the dopant particle stream. Repeat until the desired index of refraction profile in radial direction is obtained.

Step 10.

The so formed vitrified tubular silica body is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 11.

The so formed silica body is heated to a temperature of about 1370° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 75-85% solid glass density is obtained by this process.

Step 12.

The so formed vitrified tubular silica body is heated to temperature of 1360° C. and is subjected to plurality of silica particle stream introduced via ports on the chamber. The so accelerated particles collide with the substrate and deposit themselves on the substrate. Subsequent particles deposit on the material already deposited and layer by layer the silica member is formed. A porous silica body having about 65-75% fused silica density is obtained by this process.

Step 13.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 14.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 15.

Introducing silicon tetra fluoride, SiF₄, through the chamber into the deposited porous silica material for about 0.3-6 hours at temperature of 1100° C.-1400° C. the silica material is doped. The amount of the SiF₄ penetrating the cladding will be proportional to the pore density and the exposure time at given temperature of the preform.

Step 16.

The substrate and/or chamber temperature is raised to about 1400-1600° C. while rotating the substrate. The newly deposited porous silica is vitrified, and a tubular silica body having desired cladding layer wall thickness is formed. Repeat until the desired index of refraction profile in radial direction is obtained.

Step 17.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 18.

The so formed silica member is collapsed and a solid rod like silica member is formed. Undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the deposited preform.

### Example No. 9

### Fluorine Doped Cladding Having Graded Index of Refraction Fiber Optic Preform Fabrication Using Prefabricated Doped or Undoped Core Rod

Step 1.

Prefabricated silica doped or undoped rod is heated to a temperature of about 1400° C. and is subjected to plurality of silica particle streams introduced via ports on the chamber. The so accelerated particles collide with the substrate and deposit themselves on the substrate. Subsequent particles deposit on the material already deposited and layer by layer the silica member is formed. A porous silica body having about 90-100% fused silica density is obtained by this process.

Step 2.

Prefabricated silica doped or undoped rod is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 3.

The so formed silica body is heated to a temperature of about 1370° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 75-85% solid glass density is obtained by this process.

Step 4.

The so formed vitrified tubular silica body is heated to a temperature of about 1360° C. and is subjected to plurality of silica particle stream introduced via ports on the chamber. The accelerated particles collide with the substrate and deposit themselves on the substrate. Subsequent particles deposit on the material already deposited and layer by layer the silica member is formed. A porous silica body having about 65-75% fused silica density is obtained by this process.

Step 5.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 6.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 7.

Introducing silicon tetra fluoride, SiF₄, through the chamber into the deposited porous silica material for about 0.3-6 hours at temperature of about 1100° -1400° C. the silica material is doped. The amount of the SiF₄ penetrating the cladding will be proportional to the pore density and the exposure time at given temperature of the preform.

Step 8.

The substrate and/or chamber temperature is raised to about 1400-1600° C. while rotating the substrate. The newly deposited porous silica is vitrified, and a tubular silica body having desired cladding layer wall thickness is formed. Repeat until the desired index of refraction profile in radial direction is obtained.

Step 26.

The so formed silica member is vitrified and a solid rod like silica member is formed. Doped or undoped core (high index of refraction material) surrounded by graded index of refraction fluorine doped cladding (low index of refraction material) having desired diameter and length is formed. The duration of the silica deposition for certain substrate cross sections and sizes can be adjusted to allow for various ratios between the core diameter and the outside cladding layer diameter of the fiber optic preform, e.g., 1:2, 1:3, 1:5, etc. The length of the chamber and the translation capabilities can provide basis for fabrication fiber optic preforms that are up 6 inches or more in diameter and several meters in length. The radial distribution of the index of refraction in the core and the cladding will depend on the thickness of the doped layer deposited and on the pore density in the as deposited preform.

### Example No. 10

### Process For Fabrication of Fluorine Doped Cladding Tube Having Graded Index of Refraction Fiber Optic Preform Fabrication

Step 1.

Rotating and translating, a substrate consisting of porous tubing is heated to a temperature of about 1400° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 90-100% fused silica density is obtained by this process.

Step 2.

Prefabricated silica doped or undoped rod is heated to a temperature of about 1380° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 80-90% fused silica density is obtained by this process.

Step 3.

The so formed silica body is heated to a temperature of about 1370° C. and is subjected to plurality of silica particle streams introduced via ports on the chamber. The so accelerated particles collide with the substrate and deposit themselves on the substrate. Subsequent particles deposit on the material already deposited and layer by layer the silica member is formed. A porous silica body having about 75-85% solid glass density is obtained by this process.

Step 4.

The so formed vitrified tubular silica body is heated to a temperature of about 1360° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 65-75% fused silica density is obtained by this process.

Step 5.

The so formed vitrified tubular silica body is heated to a temperature of about 1330° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 50-60% fused silica density is obtained by this process.

Step 6.

The so formed vitrified tubular silica body is heated to a temperature of about 1300° C. and is subjected to plurality of silica particle streams introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 7.

Introducing silicon tetra fluoride, SiF₄, through the porous substrate and the chamber into the deposited porous silica material for about 0.3-6 hours at temperature of about 1100° C.-1400° C., the silica material is doped. The amount of the SiF₄ penetrating the cladding will be proportional to the pore density and the exposure time at given temperature of the preform.

Step 7.

The substrate and/or chamber temperature is raised to about 1400-1600° C. while rotating the substrate. The porous silica is vitrified and a tubular silica body having desired cladding layer wall thickness is formed.

Step 9.

The substrate is transferred out of the deposition chamber area and the substrate is removed. If wetting between the substrate and silica occurs, the substrate is heated to the softening point of the silica. The contact between the substrate and the silica member is melted and the substrate is removed. The duration of the silica deposition for certain substrate cross sections and sizes can be adjusted to allow for various ratios between the inner diameter and the outside diameter of the tubing fiber optic preform, e.g., 1:2, 1:3, 1:5, etc. The length of the chamber and the translation capabilities can provide basis for fabrication doped tubing for fiber optic preforms that are up 12 inches or more in diameter and several meters in length. The radial distribution of the index of refraction in the cladding will depend on the thickness of the doped layer deposited and or the pore density in the as deposited preform.

### Example No. 11

### Doped Core Having Graded Index of Refraction For Fiber Optic Preform Fabrication

Step 1.

Rotating and translating, a substrate consisting of porous tubing is heated to a temperature of about 1300° C. and is subjected to plurality of silica and dopant particle streams introduced via ports on the chamber. The accelerated particles collide with the substrate and deposit themselves on the substrate. Subsequent particles deposit on the material already deposited and layer by layer the silica member is formed. A porous silica body having about 25-35% solid glass density is obtained by this process.

Step 2.

The substrate and/or chamber temperature is raised to about 1400-1600° C. while rotating the substrate and maintained there for certain time interval. A vitrified tubular silica body having desired wall thickness is formed.

Step 3.

Rotating and translating, a substrate consisting of porous tubing is heated to a temperature of about 1300° C. and is subjected to plurality of silica particle streams and reduced concentration dopant particle stream introduced via ports on the chamber. The so accelerated particles collide with the substrate and deposit themselves on the substrate. Subsequent particles deposit on the material already deposited and layer by layer the silica member is formed. A porous silica body having about 25-35% fused silica density is obtained by this process.

Step 4.

The substrate and/or chamber temperature is raised to about 1400-1600° C. while rotating the substrate and maintained there for certain time interval. A vitrified tubular silica body having desired wall thickness is formed.

Step 5.

Rotating and translating, a substrate consisting of porous tubing is heated to a temperature of about 1300° C. and is subjected to plurality of silica particle streams and further reduced concentration dopant particle stream introduced via ports on the chamber. The accelerated particles collide with the substrate and deposit themselves on the substrate. Subsequent particles deposit on the material already deposited and layer by layer the silica member is formed. A porous silica body having about 25-35% fused silica density is obtained by this process.

Step 6.

The substrate and/or chamber temperature is raised to about 1400-1600° C. while rotating the substrate and maintained there for certain time interval. A vitrified tubular silica body having desired wall thickness is formed.

Step 7-9.

Repeat steps 4-6 further reducing the dopant levels in the deposited silica by further lowering the dopant concentrations in the dopant particle stream. Repeat until the desired index of refraction profile in radial direction is obtained.

Step 10.

The substrate is transferred out of the deposition chamber area and the substrate is removed. If wetting between the substrate and silica occurs, the substrate is heated to the softening point of the silica. The contact between the substrate and the silica member is melted and the substrate is removed.

Step 11.

The so formed silica member is collapsed and a solid rod like silica member is formed. Graded index of refraction core having desired diameter and length is formed. The duration of the silica deposition for certain substrate cross sections and sizes can be adjusted to allow for various ratios between the inner diameter and the outside diameter of the tubing fiber optic preform, e.g., 1:2, 1:3, 1:5, etc. The length of the chamber and the translation capabilities can provide basis for fabrication doped cores for fiber optic preforms that are up 12 inches or more in diameter and several meters in length. The radial distribution of the index of refraction in the cladding will depend on the thickness of the doped layer deposited and on the pore density in the deposited preform.

While the invention has been described with reference to specific embodiments, modifications and variations of the invention may be constructed without departing from the scope of the invention, which is defined in the following claims.

I claim:

1. Apparatus for producing grain of certain size and purity comprising a chamber, a valved vent connected to the chamber for withdrawing unwanted gasses, a valved vacuum line connected to the chamber for reducing pressure in the chamber, a valved gas inlet connected to the chamber for introducing inert gas into the chamber, at least one heater connected to the chamber for heating purposes and at least one plasma source connected to the chamber, a powder source connected to the chamber for supplying powder to the chamber for heating, softening, drying and purifying, and agglomerating powder particles into larger powder grains, a collector in the chamber for collecting the powder grains.

2. The apparatus of claim 1, wherein the powder is an oxide.

3. The apparatus of claim 2, wherein the oxide is selected from a group consisting of SiO₂, B₂O₅, P₂O₅, Al₂O₃, GeO₂, Sb₂O₃, Nb₂O₅, TiO₂, ZrO₂, and combinations thereof.

4. The apparatus of claim 1, wherein the powder is a nitride.

5. The apparatus of claim 4, wherein the nitride is Si₃N₄.

6. The apparatus of claim 1, wherein the powder is a compound.

7. The apparatus of claim 1, wherein the collector is positioned in the chamber beneath the plasma.

8. The apparatus of claim 7, further comprising a moving device connected to the collector for rotating the collector and raising and lowering the collector.

9. The apparatus of claim 8, wherein the valved vacuum line is located downward in the chamber for creating a differential pressure in the chamber with higher pressures toward a top of the chamber and lower pressures near a bottom of the chamber.

10. The apparatus of claim 9, wherein the plasma is centered in the chamber above the collector.

11. The apparatus of claim 10, wherein the powder is silica powder.

12. The apparatus of claim 10, wherein the powder source is connected to the chamber above the plasma.

13. The apparatus of claim 1, wherein the powder source comprises small grain powder introduction ports at a top of the chamber.

14. The apparatus of claim 1, wherein the powder source comprises a plurality of burners connected to the top of the chamber for burning precursors in the chamber and for generating the powder in the chamber.

15. The apparatus of claim 1, wherein the powder source comprises small grain powder introduction ports at a top of the chamber and a plurality of burners connected to the top of the chamber for burning precursors in the chamber and for generating the powder in the chamber.

16. The apparatus of claim 1, wherein the gas inlet is positioned in the chamber opposite the plasma for providing inert gas to the plasma.

17. The apparatus of claim 1 wherein the collector comprises a heated holder for holding the silica grains and further comprising a dopant gas input line connected to the heated holder for passing dopant gas through the silica grains in the heated holder.

18. The apparatus of claim 17, further comprising a second vacuum chamber below the first chamber.

19. The apparatus of claim 17, wherein the heated holder further comprises a crucible for softening and fusing.

20. The apparatus of claim 17, wherein the heated holder further comprises a crucible for softening and fusing silica.

21. The apparatus of claim 20, further comprising a flow director connected to the crucible for flowing the fused and softened silica from the crucible.

22. The apparatus of claim 19, further comprising a seal and a puller connected to the chamber for pulling the flowing fused silica from the chamber.

23. The apparatus of claim 23, further comprising multiple heaters and multiple heat zones in the chamber for heating the zones to different temperatures.

24. The apparatus of claim 23, wherein the multiple heat zones further comprise plural heat zones in the chamber.

25. The apparatus of claim 1, wherein the at least one heater comprises plural heaters for heating the plasma in distinct heat zones.

26. The apparatus of claim 25, wherein the at least one heater comprises plural microwave heaters for heating the chamber in distinct heat zones.

27. The apparatus of claim 25, wherein the at least one heater comprises plural radio frequency heaters for heating the plasma in distinct heat zones.

28. The apparatus of claim 25, wherein the at least one heater comprises plural microwave heaters for heating the chamber in distinct heat zones.

29. The apparatus of claim 25, wherein the at least one heater comprises plural resistive heaters for heating the chamber in distinct heat zones.

30. The apparatus of claim 25, wherein at least one heater comprises plural radiative heaters for heating the chamber in distinct heat zones.

31. The apparatus of claim 26, further comprising a plasma surface removal unit mounted beneath the seal and puller for finishing a surface of the fused silica being pulled from the chamber.

32. The apparatus of claim 1, wherein the chamber comprises a first chamber and further comprises a plate/bar fabrication vacuum chamber having an input connected to an output of the first chamber, the fabrication chamber having a plurality of valved vacuum ports, gas inlet ports, vent ports, and a fused silica feed material introduction port, resistance of RF heating connected through a plurality of feedthroughs, a crucible made from graphite, silicon carbide, ceramic material, metal or metal alloys for receiving the feed material from the first chamber, softening and solidifying the material, a plurality of ultrasound or other vibration generators in contract with the crucible for promoting proper mixing and outgassing, and additional vacuum ports placed above the softened materials for removing any gas bubbles.

33. The apparatus of claim 32, wherein the fabrication chamber comprises a plurality of chambers.

34. The apparatus of claim 1, wherein the collector further comprises fused silica fiber optic preforms, comprising a plurality of substrates relatively rotating with respect to each other in the chamber, wherein the at least one heater comprises a plurality of heaters for heating the chamber and the substrates, wherein the powder source comprises plural powder sources for directing silica particles inward in the chamber toward the substrates, fusing silica particles on the substrates, and sticking particles to particles held on the substrates and forming porous silica preforms on the substrates, and further comprising a mover for relatively moving the substrates and preforms in the chamber.

35. The apparatus of claim 34, wherein the plural powder sources comprise powder generators for generating silica particles with pyrolysis of silica particle precursors from wall-mounted burners.

36. The apparatus of claim 34, wherein the powder sources further comprise silica particle injectors for directing powder streams toward the substrates and preforms.

37. The Apparatus of claim 34, wherein the powder sources further comprise injectors for injecting jets of silica particles mixed with gas in neutral or excited plasma state.

38. The apparatus of claim 34, wherein the powder sources further comprise injectors for injecting silica particle streams that contain solid or gaseous dopants and gases in neutral or excited charged, plasma state.

39. The apparatus of claim 34, further comprising dopant gas injectors in the chamber and substrate, purge gas injectors in the chamber and substrate, and vents connected to the chamber for venting and removing gases form the chamber.

40. The apparatus of claim 34, wherein the mover comprises relatively rotating and translating movers connected to the substrates and preforms within the chamber.

41. The apparatus of claim 1, wherein the powder source comprises burners mounted near walls of the chamber for pyrolysis of silicon compositions for generating silica powder.

42. The apparatus of claim 1, further comprising a dopant source comprising burners mounted near or on the walls of the chamber for pyrolysis of dopant compositions for generating dopants in the chamber.

43. The apparatus of claim 1, further comprising dopant powder sources comprising dopant powder injectors near or on chamber walls.

44. The apparatus of claim 1, wherein the powder source comprises silica powder injectors near walls of the chamber.

45. The apparatus of claim 1, further comprising a mover having rotation and translation mechanisms connected to the collector for rotating and translating the collector in the chamber.

46. Apparatus for forming a fused silica grains, comprising an elongated chamber, a pressure control connected to the chamber, controlling pressure in the chamber, at least one collector mounted in the chamber, silica particle providers connected to the chamber for supplying silica particles in the chamber and directing the silica particles toward the collector, at least one heater connected to or near the chamber wall for supplying heat to the collector and at least one heater in the chamber and for directing heat to the silica particles for softening surfaces of the particles for sticking and agglomerating the particles on other heated particles and on the collector for collecting the particles with softened surfaces on the collector.

47. The apparatus of claim 46, further comprising a rotation assembly mounted on the chamber and connected to the at least one collector for relatively rotating the collector with respect to the chamber.

48. The apparatus of claim 46, wherein the pressure control comprises at least one reduced pressure port in the chamber for venting and withdrawing gas.

49. The apparatus of claim 46, further comprising at least one inlet port in the chamber for introducing purgant, dopant or oxidant gas into the chamber.

50. The apparatus of claim 46, wherein the at least one heater comprises at least one radiant heater in the chamber for directing heat to the silica particles in the chamber.

51. The apparatus of claim 50, wherein the radiant heater is a resistive heater.

52. The apparatus of claim 50, wherein the radiant heater is an infrared heater.

53. The apparatus of claim 46, wherein the at least one heater comprises a radio frequency heater in the chamber for directing heat to the at least one collector and the particles in the chamber.

54. The apparatus of claim 46, wherein the at least one heater comprises a microwave heater.

55. The apparatus of claim 46, wherein the at least one heater comprises plural heaters in the chamber for heating plural heat zones along the elongated chamber.

56. The apparatus of claim 46, further comprising a translation mechanism connected to the chamber and the collector for relatively translating the collector with respect to the chamber.

57. The apparatus of claim 46, wherein the silica particle providers comprise burners for introducing and pyrolysizing compounds in the chamber for providing the silica particles in the chamber.

58. The apparatus of claim 46, wherein the silica particle providers comprise silica powder stream injectors in the chamber for directing preformed silica powder toward the collector.

59. The apparatus of claim 46, further comprising a crucible with a heated throat for fusing and softening the silica and an openable lower end for flowing softened fused silica.

60. The apparatus of claim 59, further comprising a rotating and pulling mechanism near a lower end of the chamber for rotating and pulling the softened fused silica from the chamber.

61. The apparatus of claim 60, wherein the softened and fused silica is pulled from the chamber as a tube.

62. The apparatus of claim 60, wherein the softened and fused silica is pulled from the chamber as a rod.

63. The apparatus of claim 60, wherein the at least one heater further comprises a resistance heater connected to the crucible for softening fused silica in the crucible.

64. The apparatus of claim 60, further comprising electrodes near the softened silica and an electric field generator connected to the electrodes for providing an electric field in the softened silica.

65. The apparatus of claim 64, wherein at least one of the electrodes is on one side of the softened silica, and wherein at least one other of the electrodes is on an opposite side of the softened silica for providing an electric field through the softened silica.

66. The apparatus of claim 65, wherein the softened silica flowing from the preform forms a tubular bubble, wherein the at least one of the electrodes is outside of the tubular bubble, and wherein the at least one other of the electrodes is within the tubular bubble.

67. The apparatus of claim 66, wherein the electrodes are concentric ring electrodes.

68. The apparatus of claim 60, further comprising a second chamber having a crucible tray for receiving the softened silica from the first chamber, and at least one second chamber heater in the second chamber for heating the fused softened silica and reforming the silica in a desired form in the crucible tray.

69. The apparatus of claim 68, further comprising ultra sound or other oscillating frequency generators in the second chamber adjacent the crucible tray for outgassing gas from the softened reformed fused silica.

70. The apparatus of claim 69, further comprising additional vacuum ports near the crucible tray for removing gases outgassed from the softened reformed fused silica.

71. The apparatus of claim 46, wherein the particle providers are mounted in an upper part of the chamber and are oriented for directing particles inward into a mass of particles, and wherein the at least one heater comprises a resistive, radio frequency, plasma heating or other heater for heating particles and softening surfaces of the particles in the mass of particles, and wherein the collector comprises a first heated crucible positioned with respect to the mass of particles for collecting particles and agglomerations of particles from the mass, the first heated crucible having a lower heated throat with a heater for softening, fusing and flowing fused silica from the first crucible.

72. The apparatus of claim 71, further comprising a flow director mounted beneath the lower heated throat for directing flow of the flowing fused silica as a tubular or solid member having round, rectangular or polygonal cross-section.

73. The apparatus of claim 72, further comprising a purging gas or dopant injector connected to the flow director for supplying purging gas or dopant to the flowing fused silica.

74. The apparatus of claim 73, further comprising a second crucible positioned below the heated throat for receiving flowing fused silica, and a purging gas or dopant injector in the second crucible for injecting purging gas or dopant in the fused silica in the second crucible.

75. The apparatus of claim 74, further comprising a second chamber having a crucible tray for receiving the softened silica from the second crucible, and at least one second chamber heater in the second chamber for heating the fused softened silica and reforming the silica in a desired form in the crucible tray.

76. The apparatus of claim 75, further comprising ultra sound or other oscillations generators in the second chamber adjacent the crucible tray for outgassing gas from the softened reformed fused silica in the crucible tray.

77. The apparatus of claim 76, further comprising vacuum ports near the crucible tray for removing gases outgassed from the softened reformed fused silica.

78. A method for producing silica grain comprising providing a chamber, providing a valved vent connected to the chamber, and withdrawing unwanted gasses, providing a valved vacuum line connected to the chamber and reducing pressure in the chamber, providing a valved gas inlet connected to the chamber and introducing inert gas into the chamber, providing at least one heater connected to the chamber and forming a hot plasma in the chamber, providing a silica powder source connected to the chamber and supplying silica powder to the hot plasma in the chamber, heating, softening, drying and removing OH, and agglomerating powder particles into larger silica grains and providing a collector in the chamber for collecting the silica grains.

79. The method of claim 78, further comprising positioning the collector in the chamber beneath the plasma.

80. The method of claim 79, further comprising providing a moving device connected to the collector and rotating the collector and raising and lowering the collector.

81. The method of claim 80, further comprising locating the valved vacuum line downward in the chamber and creating a differential pressure in the chamber with higher pressures toward a top of the chamber and lower pressures near a bottom of the chamber.

82. The method of claim 81, further comprising centering the plasma in the chamber above the collector.

83. The method of claim 82, further comprising connecting the silica powder source to the chamber above the plasma.

84. The method of claim 83, wherein the providing the silica powder source comprises providing small grain silica powder introduction ports near a top of the chamber.

85. The method of claim 83, wherein the providing the silica powder source comprises providing a plurality of burners connected to the top of the chamber, burning silica precursors in the chamber and generating the silica powder in the chamber.

86. The method of claim 83, wherein the providing the silica powder source comprises providing small grain silica powder introduction ports at a top of the chamber and providing a plurality of burners connected to the top of the chamber, burning silica precursors in the chamber and generating the silica powder in the chamber.

87. The method of claim 86, wherein the supplying the silica powder comprises introducing the silica powder together with a gas plasma or a plasma/neutral gas mixture.

88. The method of claim 78, further comprising positioning the gas inlet in the chamber opposite the plasma and providing inert gas to the plasma.

89. The method of claim 78, wherein the introducing the inert gas comprises introducing pure inert gas.

90. The method of claim 78, wherein the introducing the inert gas comprises introducing an inert gas mixed with other inert gasses.

91. The method of claim 78, wherein the introducing the inert gas comprises introducing an inert gas mixed with reactive gas for additional silica powder purification

92. The method of claim 78, wherein providing the collector comprises providing a heated holder, holding the silica grains on the holder, and further comprising providing a purging, reactive or dopant gas input line connected to the heated holder and passing purging, reacting, or dopant gas through the silica grains on the heated holder.

93. The method of claim 92, wherein the providing the purging reactive or dopant gas comprises providing chemically reactive gas, plasma or gas plasma and neutral mix.

94. The method of claim 92, further comprising providing a second vacuum chamber below the first chamber.

95. The method of claim 92, wherein the providing the heated holder further comprises providing a crucible, and softening, fusing and flowing the silica.

96. The method of claim 95, further comprising providing a flow director connected to the crucible and flowing the fused softened silica from the crucible.

97. The method of claim 95, further comprising providing a seal and a puller connected to the chamber and pulling the flowing fused silica from the chamber.

98. The method of claim 78, further comprising providing multiple heat zones in the chamber and heating the zones to different temperatures.

99. The method of claim 97, wherein providing the multiple heat zones further comprises providing plural heat zones adjacent the plasma and heating the plasma in the distinct heat zones.

100. The method of claim 98, wherein the providing the multiple heat zones comprises providing plural microwave heaters and heating the plasma in distinct heat zones.

101. The method of claim 78, wherein the providing the at least one heater comprises providing plural microwave heaters and heating the chamber in distinct heat zones.

102. The method of claim 78, wherein the providing the at least one heater comprises providing plural radio frequency heaters and heating the plasma in distinct heat zones.

103. The method of claim 78, wherein the providing the at least one heater comprises providing resistive, RF and IR heaters and heating the chamber in distinct heat zones.

104. The method of claim 78, wherein the providing the at least one heater comprises providing resistive, RF and IR heaters and heating the plasma in distinct heat zones.

105. The method of claim 78, wherein the forming a hot plasma comprises providing a plurality of microwave plasma generators for producing plasma for the chamber.

106. The method of claim 97, further comprising providing a gas plasma surface removal unit mounted beneath the seal and puller and finishing a surface of the tube being pulled from the chamber.

107. The method of claim 78, further comprising providing a plate/bar fabrication vacuum chamber having an input connected to an output of the first chamber, providing on the fabrication chamber a plurality of valved vacuum ports, gas inlet ports, vent ports, providing a fused silica feed material introduction port, as the input, providing resistance or RF heating connected through a plurality of feedthroughs, providing a crucible tray made from graphite, silicon carbide, ceramic material, metal or metal alloys for receiving the feed material from the first chamber, softening and solidifying of the material in the crucible tray, providing a plurality of ultrasound or other oscillation generators in contact with the crucible tray for promoting proper mixing and outgassing, and providing additional vacuum ports above the softened materials for removing any gas bubbles.

108. The method of claim 107, wherein providing the fabrication chamber comprises providing a plurality of fabrication chambers.

109. A method of producing fused silica fiber optic preforms, comprising providing relatively rotating a plurality of substrates with respect to each other in a chamber, heating the chamber and the substrates, directing silica particles and dopant inward in the chamber toward the substrates, heating the substrates, fusing silica particles on the substrates, and sticking particles to particles held on the substrates and forming silica preforms on the substrates, and relatively moving the substrates and preforms in the chamber.

110. The method of claim 109, wherein the providing of silica particles comprises generating silica particles with pyrolysis of silica particle precursors from wall-mounted burners.

111. The method of claim 109, wherein the directing further comprises directing silica particle streams toward the substrates and preforms.

112. The method of claim 111, further comprising mixing the streams of silica particles with neutral or plasma gases.

113. The method of claim 111, further comprising mixing the streams of silica particles with dopant and neutral or plasma gases.

114. The method of claim 111, further comprising providing dopant gases to the chamber and through the substrate, and providing purge gas to the chamber and through the substrate, and venting and removing gases from the chamber.

115. The method of claim 109, wherein the moving comprises relatively rotating and translating the substrates and preforms within the chamber.

116. The method of claim 109, wherein the directing silica particles comprises providing burners mounted near walls of the chamber, pyrolyzing silicon compositions and generating silica powder.

117. The method of claim 109, wherein the directing silica particles comprises providing silica powder injectors near walls of the chamber.

118. The method of claim 109, wherein the moving further comprises providing a mover, providing rotation and translation mechanisms connected to the substrates and rotating and translating the substrates in the chamber.

119. A method for providing fused silica grains, comprising providing an elongated chamber, providing a pressure control connected to the chamber, controlling pressure in the chamber, providing at least one collector mounted in the chamber, disposing silica particle providers connected to the chamber and supplying doped and undoped silica particles in the chamber, and directing the silica particles toward the at least one collector, providing at least one heater connected to the chamber, supplying heat to the collector and supplying heat to the chamber, directing heat to the silica particles, softening surfaces of the particles, sticking and agglomerating the particles with other heated particles, and with the collector and collecting the particles.

120. The method of claim 119, further comprising providing a rotation assembly mounted on the chamber, connecting the rotating assembly to the at least one collector and relatively rotating the collector with respect to the chamber.

121. The method of claim 119, wherein the providing the pressure control comprises providing at least one reduced pressure port in the chamber and venting and withdrawing gas.

122. The method of claim 119, further comprising providing at least one inlet port in the chamber and introducing purgant, dopant or oxidant gas into the chamber.

123. The method of claim 119, wherein providing the at least one heater comprises providing at least one radiant heater in the chamber and directing heat to the silica particles in the chamber.

124. The method of claim 119, wherein providing the at least one heater comprises providing a radio frequency heater in the chamber and directing heat to the substrate, the preform and the particles in the chamber.

125. The method of claim 119, wherein providing the at least one heater comprises providing a microwave gas plasma generator.

126. The method of claim 119, wherein providing the at least one heater comprises providing plural heaters in the chamber and heating plural heat zones along the elongated chamber.

127. The method of claim 119, further comprising providing a translation mechanism connected to the chamber and the collector and relatively translating the collector with respect to the chamber.

128. The method of claim 119, wherein the disposing the silica particle providers comprises providing burners for introducing and pyrolyzing or oxidizing compounds in the chamber and providing the silica particles in the chamber.

129. The method of claim 119, wherein the disposing the silica particle providers comprise providing silica powder stream injectors in the chamber and directing preformed silica powder toward the collector.

130. The method of claim 119, further comprising providing a crucible with a heated throat fusing and softening the silica and an open lower end and flowing the softened fused silica.

131. The method of claim 130, further comprising providing a rotating and pulling mechanism near a lower end of the chamber and rotating and pulling the softened fused silica from the chamber.

132. The method of claim 131, wherein pulling the softened and fused silica comprises pulling the silica from the chamber as a tube.

133. The method of claim 131, wherein pulling the softened and fused silica comprises pulling the silica from the chamber as a rod.

134. The method of claim 131, wherein providing the at least one heater further comprises providing a resistance heater connected to the crucible and softening fused silica in the crucible.

135. The method of claim 137, further comprising providing electrodes near the softened silica, providing an electric field generator connected to the electrodes and providing an electric field in the softened silica.

136. The method of claim 135, wherein the providing the electrodes comprises providing at least one of the electrodes on one side of the softened silica, providing at least one other of the electrodes on an opposite side of the softened silica and providing the electric field through the softened silica.

137. The method of claim 136, wherein the flowing the softened silica comprises forming a tubular bubble, wherein the providing the electrodes comprises providing the at least one of the electrodes outside of the tubular bubble, and providing the at least one other of the electrodes within the tubular bubble.

138. The method of claim 137, wherein the providing the electrodes comprises providing concentric ring electrodes.

139. The method of claim 131, further comprising providing a second chamber providing a crucible tray, receiving the softened silica from the first chamber, and providing at least one second chamber heater in the second chamber, heating the fused softened silica and reforming the silica in a desired form in the crucible tray.

140. The method of claim 139, further comprising providing ultrasound or other oscillation generators in the second chamber adjacent the crucible tray and outgassing gas from the softened reformed fused silica.

141. The method of claim 140, further comprising providing additional vacuum ports near the crucible tray and removing gases outgassed from the softened reformed fused silica.

142. The method of claim 119, wherein the disposing comprises mounting the particle providers in an upper part of the chamber and directing particles inward into a mass of particles, wherein providing the at least one heater comprises providing a resistive, radio frequency, plasma or other heater and heating particles and softening surfaces of the particles in the mass of particles, and wherein the providing the collector comprises providing a first heated crucible positioned with respect to the mass of particles collecting softened particles and agglomerations of softened surface particles from the mass in the first heated crucible, providing a lower throat, heating the throat, softening, fusing and flowing fused silica from the first crucible through the throat.

143. The method of claim 142, further comprising providing a flow director mounted beneath the lower heated throat and flowing of the flowing fused silica as a tubular or solid member having round, rectangular or polygonal cross-section.

144. The method of claim 143, further comprising connecting a purging or dopant injector to the flow director and supplying purging gas and dopant to the flowing fused silica.

145. The method of claim 143, further comprising positioning a second crucible below the heated throat and receiving flowing fused silica, and providing a purging gas or dopant injector in the second crucible and injecting purging gas or dopant in the fused silica in the second crucible.

146. The method of claim 149, further comprising providing a second chamber providing a crucible tray in the second chamber, receiving the softened silica from the first chamber in the crucible tray, and providing at least one second chamber heater in the second chamber, heating the fused softened silica and reforming the silica in a desired form in the crucible tray.

147. The method of claim 146, further comprising providing ultrasound or other oscillation generators in the second chamber adjacent the crucible tray and outgassing gas from the softened reformed fused silica.

148. The method of claim 147, further comprising providing additional vacuum ports near the crucible tray and removing gases outgassed from the softened reformed fused silica.
